(19) United States
(12) Patent Application Publication
(10) Pub. No.: US 2013/0252096 A1
(43) Pub. Date: Sep. 26, 2013

(54) Nonaqueous Electrolyte Rechargeable Battery Having Electrode Containing Conductive Polymer

(71) Applicants: DENSO CORPORATION, Kariya-city (JP); JAPAN CARLIT CO., LTD., Tokyo (JP)

(72) Inventors: Ryuta Kobayakawa, Kariya-city (JP); Kyohei Usami, Inazawa-city (JP); Shigeki Komine, Nagoya-city (JP); Masaaki Tamura, Shibukawa-city (JP); Tomohiko Abe, Tokyo (JP); Makoto Kodaira, Shibukawa-city (JP)

(73) Assignees: JAPAN CARLIT CO., LTD., Tokyo (JP); DENSO CORPORATION, Kariya-city (JP)

(21) Appl. No.: 13/833,802

(22) Filed: Mar. 15, 2013

(30) Foreign Application Priority Data
Mar. 20, 2012 (JP) 2012-062952

(51) Int. Cl. H01M 4/60

(52) U.S. Cl. CPC H01M 4/606
USPC 429/213; 429/209; 429/231.95

(57) ABSTRACT

A nonaqueous electrolyte rechargeable battery includes a positive electrode, a negative electrode, and an electrolyte solution. The positive electrode includes a positive-electrode active material that occludes and discharges an alkali metal ion. The negative electrode includes a negative-electrode active material that occludes and discharges an alkali metal ion. At least one of the positive electrode and the negative electrode contains a conductive polymer. The conductive polymer has a fiber-form or a three-dimensional structure provided by the fiber-form as a base, the fiber-form having a fiber diameter of equal to or less than 100 nm and an aspect ratio of equal to or greater than 10.

### CROSS REFERENCE TO RELATED APPLICATION

This application is based on Japanese Patent Application No. 2012-62952 filed on Mar. 20, 2012, the disclosure of which is incorporated herein by reference.

### TECHNICAL FIELD

The present disclosure relates to a nonaqueous electrolyte rechargeable battery having an electrode containing a conductive polymer.

### BACKGROUND

With market expansion of electronic devices, such as laptop computers, cell phones and electronic cameras, rechargeable batteries for driving such electronic devices have been increasingly required. With regard to such electronic devices, power consumption is likely to high in accordance with high-functions, whereas it is expected to be compact. Therefore, it is required to increase the capacity of the rechargeable battery. Although there are various kinds of rechargeable batteries, a nonaqueous electrolyte rechargeable battery, such as, a lithium ion rechargeable battery, is widely used in the electronic devices as a high-capacity battery.

In addition to the use of the nonaqueous electrolyte rechargeable battery in the electronic devices, it has been considered to use the nonaqueous electrolyte, rechargeable battery in various other devices such as devices for vehicles and houses, which generally uses a large amount of electricity.

For example, JP10-188985A describes a technology of improving performance of a nonaqueous electrolyte rechargeable battery. JP10-188985A describes a lithium ion rechargeable battery having a positive electrode containing a lithium compound oxide, which is conventionally used as a positive-electrode active material, and polyaniline. The polyaniline is added as a high-capacity oxidation-reduction (redox) agent. Because the polyaniline exerts a capacitor effect, the capacity of the lithium ion rechargeable battery improves.

However, a conductive property of the polyaniline is low. In the lithium ion rechargeable battery of JP10-188985A, therefore, an internal resistance of the positive electrode is likely to increase due to the polyaniline. As a result, it is difficult to sufficiently improve an output characteristic of the electrode.

In a rechargeable battery, an electrode is formed by depositing an electrode mixture, which is composed of an organic solvent and an electrode active material dispersed in the organic solvent, on a surface of an electrode collector. In view of an environmental issue and recovery of the solvent, an aqueous mixture has been used in place of the solvent.

However, when the aqueous mixture is used, the internal resistance of the electrode is likely to increase, resulting in decrease in output of the rechargeable battery.

It will be considered to employ the technology of JP10-188985A to a rechargeable battery that uses the aqueous mixture. However, since the conductive property of the polyaniline contained in the positive electrode is low, the internal resistance of the positive electrode is still high. Therefore, it will be difficult to sufficiently improve the output characteristic of the rechargeable battery.

### SUMMARY

According to an aspect of the present disclosure, a nonaqueous electrolyte rechargeable battery includes a positive electrode, a negative electrode, and an electrolyte solution. The positive electrode includes a positive-electrode active material that occludes and discharges alkali metal ions. The negative electrode includes a negative-electrode active material that occludes and discharges alkali metal ions. At least one of the positive electrode and the negative electrode contains a conductive polymer that has one of a fiber-form and a three-dimensional structure provided by the fiber-form as a base. The fiber-form has a fiber diameter equal to or less than 100 nm in a cross-section defined perpendicular to its longitudinal axis and an aspect ratio equal to or greater than 10.

The conductive polymer having one of the fiber-form and the three-dimensional structure provided by the fiber-form improves a conductive property of the electrode. Therefore, a resistance characteristic of the electrode improves, and an output characteristic of the nonaqueous electrolyte rechargeable battery improves.

### BRIEF DESCRIPTION OF THE DRAWING

The above and other objects, features and advantages of the present disclosure will become more apparent from the following detailed description made with reference to the accompanying drawing, in which:

FIG. 1 is a diagram illustrating a cross-sectional view of a coin-type rechargeable battery, as an example of a nonaqueous electrolyte rechargeable battery, according to an embodiment of the present disclosure; and

FIG. 2 is a diagram illustrating a schematic view of a form of a conductive polymer contained in an electrode of the nonaqueous electrolyte rechargeable battery according to the embodiment.

### DETAILED DESCRIPTION

A nonaqueous electrolyte rechargeable battery according to an embodiment includes a positive electrode, a negative electrode, and an electrolyte solution. The positive electrode includes a positive-electrode active material that occludes and discharges alkali metal ions. The negative electrode includes a negative-electrode active material that occludes and discharges alkali metal ions. At least one of the positive electrode and the negative electrode contains a conductive polymer that has one of a fiber-form and a three-dimensional structure provided by the fiber-form as a base. That is, the positive electrode, or the negative electrode, or both the positive electrode and the negative electrode contains the conductive polymer. The conductive polymer has the fiber-form, or the three-dimensional structure provided by the fiber-form. The fiber-form has a fiber diameter equal to or less than 100 nm in a cross-section defined perpendicular to its longitudinal axis and an aspect ratio equal to or greater than 10.

The conductive polymer having one of the fiber-form and the three-dimensional structure provided by the fiber-form as a base improves a conductive property of the electrode. Therefore, a resistance characteristic of the electrode improves, and an output characteristic of the nonaqueous electrolyte rechargeable battery improves.

In a case where the electrode contains the conductive polymer described above, a conductive path is provided in an electrode mixture. Namely, the conductive polymer improves conductivity of the electrode.

In a case where the diameter of the fiber-from is greater than 100 nm or the aspect ratio of the fiber-form is less than 10, the three-dimensional structure of the conductive polymer is insufficient. Therefore, the conductive path is not formed in the electrode mixture. Namely, such a conductive polymer increases the resistance in the electrode.

In a nonaqueous electrolyte rechargeable battery according to an embodiment, the conductive polymer is provided by polymerizing aniline represented by a formula 1 or a derivative of the aniline as a monomer unit.

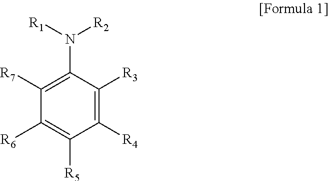

In the formula 1, R₁ to R₇ are selected from a group consisting of hydrogen, C1 to C6 straight-chain or branched alkyl group, C1 to C6 straight-chain or branched alkoxy group, hydroxyl group, nitro group, amino group, phenyl group, aminophenyl group, diphenylamino group, and halogen group. Here, C1 to C6 mean carbon numbers 1 to 6.

In an nonaqueous electrolyte rechargeable battery according to an embodiment, the conductive polymer is provided by polymerizing aniline or the derivative of the aniline as a monomer unit, and is further doped with a dopant.

In a case where the conductive polymer is provided by doping a predetermined dopant to a polymer that is polymerized with predetermined compound as a monomer unit, a predetermined function is provided in the conductive polymer by the dopant. The dopant is, for example, bis(fluorosulfonyl)imide. In such a case, the conductive polymer has the three-dimensional structure having the fiber-form as the base and exerts excellent conductivity, even in the electrolyte solution.

The conductive polymer is provided by doping a predetermined dopant to a polymer that is polymerized with predetermined compound as a monomer unit. Therefore, a predetermined function is added to the polymer. Namely, the polymer exhibits a desired characteristic depending on the dopant doped in the polymer. Namely, in the nonaqueous electrolyte rechargeable battery, a dopant may be added to provide a further different function.

The kind of the nonaqueous electrolyte rechargeable battery according to the embodiments is not limited to a specific one. The nonaqueous electrode rechargeable battery according to the embodiments includes a positive electrode including a positive-electrode active material that occludes and discharges alkali metal ions, a negative electrode including a negative-electrode active material that occludes and discharges alkali metal ions, and an electrolyte solution. Further, at least one of the positive electrode and the negative electrode contains the conductive polymer. The alkali metal ions, and the positive electrode, the negative electrode are not limited to specific ones, and may have conventional structures or compositions.

The alkali metal ion may be any ion of an alkali metal, such as lithium and sodium. For example, the alkali metal ion is a lithium ion.

The conductive polymer may be contained in one of the positive electrode and the negative electrode, or both of the positive electrode and the negative electrode.

In a case where the nonaqueous electrolyte rechargeable battery is a lithium ion rechargeable battery, the conductive polymer may be contained in the positive electrode. In such a case, the positive electrode contains a positive-electrode active material including a lithium transition metal composite compound and the conductive polymer.

In a case where the nonaqueous electrolyte rechargeable battery is a lithium ion rechargeable battery, the positive-electrode active material may include polyanion-type, such as iron lithium phosphate.

Hereinafter, an embodiment of the present disclosure will be described more in detail.

A nonaqueous electrolyte rechargeable battery has a structure similar to a conventional nonaqueous electrolyte rechargeable battery, except that at least one of the positive electrode and the negative electrode includes the conductive polymer described above.

For example, the negative electrode is formed in a following manner. A negative-electrode mixture including a negative-electrode active material, a conductive agent and a binder is suspended and mixed in a suitable solvent to prepare a slurry. The slurry is applied to one surface or both surfaces of a collector. The collector on which the slurry has been applied is dried. Thus, the negative electrode is produced.

The negative-electrode active material may include a carbon material. Further, the negative electrode active material may include any material other than the carbon material. For example, the material may be a simple substance or an alloy of a meal element of IVB group or a metalloid element in a short-period-type periodic table. For example, the material may include silicon (Si) or tin (Sn).

As the conductive agent of the negative electrode, a carbon material, metal powder, a conductive polymer and the like may be used. Considering conductivity and stability, carbon black, such as acetylene black and Ketjen black, and other carbon materials, such as vapor-grown carbon fiber (VGCF) may be used as the conductive agent.

Examples of the binder of the negative electrode may be polytetrafluoroethylene (PTFE), polyvinylidene fluoride (PVDF), fluororesin copolymer (ethylene-tetrafluoride hexafluoride propylene copolymer), SBR, acrylic-based rubber, fluorine-based rubber, polyvinyl alcohol (PVA), styrene maleic acid resin, polyacrylate, carboxyl methyl cellulose (CMC), and the like.

The solvent of the negative electrode may be an organic solvent, such as N-methyl-2-pyrrolidone (NMP), water, and the like.

The negative-electrode collector may be a known collector. For example, the negative-electrode collector may be provided by a metal foil or a metal mesh made of copper, stainless steel, titanium or nickel.

For example, the positive electrode is formed in the following manner. A positive-electrode mixture including a positive electrode active material, a conductive agent and a binder is suspended and mixed in a suitable solvent to form a slurry. The slurry is applied to one surface or both surfaces of a collector. The collector on which the slurry has been applied is dried. Thus, the positive electrode is produced.

As examples of the positive-electrode active material, an oxide, a sulfide, a lithium-containing oxide, a conductive polymer and the like may be used. For example, the positive-electrode active material may be LiFePO₄, LiMnPO₄, Li₂MnSiO₄, Li₂MnₓFe₁₋ₓSiO₄, MnO₂, TiS₂, TiS₃, MoS₃, FeS₂, Li₁₋ₓMnO₂, Li₁₋ₓMn₂O₄, Li₁₋ₓCoO₂, Li₁₋ₓNiO₂, LiV₂O₃, V₂O₅, polyaniline, polyparaphenylene, polyphenylene sulfide, polyphenylene oxide, polythiophene, polypyrrole, these derivatives, and a stable radical compound. In these examples of the positive-electrode active material, z is the number equal to or greater than 0 and equal to or less than 1. Further, in these examples, Li, Mg, Al or a transition metal, such as Co, Ti, Nb, or Cr, may be added to or substituted for each element. These lithium-metal composite oxides may be solely used. Alternatively, a plurality of kinds of these oxides may be mixed and used together. Among these examples, the lithium-metal composite oxide may be one or more elements selected from lithium manganese-containing multiple oxide having a lamination structure or a spinel structure, lithium nickel-containing multiple oxide, and lithium cobalt-containing multiple oxide. In the present embodiment, as the positive-electrode active material, a polyanion-type, such as iron lithium phosphate, is used.

The conductive agent of the positive electrode may not be limited to a specific one, but may be fine particles of graphite, carbon black, such as acetylene black, ketjen black, and carbon nano fiber, and fine particles of amorphous carbon, such as needle coke.

The binder of the positive electrode may not be limited to a specific one, but may be PVDF, ethylene-propylene-diene copolymer (EPDM), SBR, acrylonitrile-butadiene rubber (NBR), and fluororubber, in addition to the examples of the binder of the negative electrode.

As the solvent for dispersing the positive-electrode material and the like, an organic solvent for dissolving the binder is generally used. The solvent of the positive electrode may not be limited to a specific one, but may be NMP, dimethylformamide, dimethylacetamide, methyl ethyl ketone, cyclohexanone, methyl acetate, methyl acrylate, diethyltriamine, N—N-dimethylaminopropylamine, ethylene oxide, tetrahydrofuran and the like. The solvent may be provided by a slurry that is made by adding a thickener and a dispersion agent such as carboxymethylcellulose (CMC) to water.

The electrolyte solution of the present embodiment has a similar structure to a known nonaqueous electrolyte solution, except that the electrolyte solution of the present embodiment is a liquid in which an electrolyte is dissolved in a solvent that contains at least one selected from EC, VC, DMC, EMC, and DMC as a main material. The electrolyte dissolved in the electrolyte solution may be an electrolyte that is used in a known nonaqueous electrolyte solution.

The electrolyte may not be limited to a specific one, but may be at least one of an inorganic salt selected from LiPF₆, LiBF₄, LiClO₄, and LiAsF₆, a derivative of these inorganic salts, and an organic salt selected from LiSO₃CF₃, LiC(SO₃CF₃)₃, LiN(SO₂CF₃)₂, LiN(SO₂C₂F₅)₂, and LiN(SO₂CF₃)(SO₂C₄F₉), and a derivative of these organic salts. These electrolytes contribute to further improve a battery performance and to keep the battery performance also in a temperature region other than a room temperature. The concentration of the electrolyte may not be limited to a specific concentration. The concentration may be suitably decided depending on use of the rechargeable battery, considering the kinds of the electrolyte and the organic solvent.

The nonaqueous electrolyte rechargeable battery of the present embodiment may include a separator as an electrical insulator to insulate the positive electrode and the negative electrode from one another, and to hold the electrolyte solution. For example, the separator may be provided by a porous synthetic resin film, such as a porous film of polyolefin-based polymer (e.g., polyethylene, polypropylene). Since the separator needs to keep the insulation between the positive electrode and the negative electrode, the size of the separator may be greater than the positive electrode and the negative electrode.

The nonaqueous electrolyte rechargeable battery may include other elements, in addition to the elements described above. The shape of the nonaqueous electrolyte rechargeable battery of the present embodiment may not be limited to a specific one. For example, the nonaqueous electrolyte rechargeable battery may have a coin-cell shape, a cylindrical shape, a square or rectangular shape, or any other shape. Also, a shape and a material of a case of the nonaqueous electrolyte rechargeable battery of the present embodiment may not be limited to specific ones. The case may be made of a metal or a resin. The case may be provided by a soft case such as a laminate package. The case may be provided by any other formation as long as an outer shape of the rechargeable battery can be kept.

<Manufacturing Method>

A manufacturing method of the nonaqueous electrolyte rechargeable battery of the present embodiment is not limited to a specific method. For example, the nonaqueous electrolyte rechargeable battery of the present embodiment may be manufactured by a known method of a conventional nonaqueous electrolyte rechargeable battery, except that the conductive polymer is added as at least one of the positive-electrode active material and the negative-electrode active material in the nonaqueous electrolyte rechargeable battery of the present embodiment.

### EXAMPLES

The nonaqueous electrolyte rechargeable battery of the embodiment will be hereinafter described in detail based on the following examples.

As examples of the nonaqueous electrolyte rechargeable battery of the present disclosure, coin-type lithium ion rechargeable batteries were prepared. The followings are examples to implement the present disclosure, and the present disclosure is not limited to the following examples. In the following description, “%” represents “mass %”.

<Synthesis of De-Doping Polyaniline (1)>

5 g of aniline and 20 g of 35% hydrochloric acid were inserted to 100 g of ion exchange water, and stirred well such that the aniline and the hydrochloric acid are evenly dissolved in the ion exchange water. Then, this solution was cooled to 0 degrees Celsius. Thus, an aniline hydrochloric acid solution was prepared. Separately, an aqueous solution was prepared by dissolving 12 g of ammonium persulfate in 40 g of ion exchange water.

The ammonium persulfate aqueous solution was slowly dropped into the aniline hydrochloric acid solution while stirring the aniline hydrochloric acid solution. Then, this solution was held at 0 degrees Celsius for five hours to carry out a reaction. The product was filtered, washed and dried. Thus, 6 g of polyaniline powder was obtained.

The polyaniline power was stirred in 100 g of 5% aqueous ammonia to perform a de-dope treatment. Then, the product was filtered, washed and dried. Thus, de-doping polyaniline (1) was obtained.

When the form of the de-doping polyaniline (1) was observed through a scanning electron microscope, the de-doping polyaniline (1) had a fiber-form having a fiber diameter of 10 nm and an aspect ratio of 50. Here, the fiber diameter is provided in a cross-section defined perpendicular to a longitudinal axis of the fiber.

Further, the de-doping polyaniline (1) was formed into a disc-shaped pellet having a diameter of 13 mm and a thickness of 0.5 mm by a tablet forming device. Then, an electric conductivity of the pellet of the de-doping polyaniline (1) was measured by a resistivity meter (e.g., Loresta GP Model MCP-T600 of MITSUBISHI CHEMICAL ANALYTECH CO., LTD). The pellet of the de-doping polyaniline (1) had the electric conductivity of equal to or less than a measurement lower limit, that is, equal to or less than 10⁻³ S/cm.

<Synthesis of De-Doping Polyaniline (2)>

5 g of aniline and 12.5 g of 10-camphor sulfonic acid were inserted to 100 g of ion exchange water, and stirred well such that the aniline and the 10-camphor sulfonic acid are evenly dissolved in the ion exchange water. Then, this solution was cooled to 0 degrees Celsius. Thus, an aniline 10-camphor sulfonic acid solution was prepared. Separately, an aqueous solution was prepared by dissolving 12 g of ammonium persulfate in 40 g of ion exchange water.

The ammonium persulfate aqueous solution was slowly dropped into the aniline 1-camphor sulfonic acid solution while stirring the aniline 10-camphor sulfonic acid solution. Then, this solution is held at 0 degrees Celsius for five hours to carry out a reaction. The product was filtered, washed and dried. Thus, 6.5 g of polyaniline powder was obtained.

The polyaniline power was stirred in 100 g of 5% aqueous ammonia to perform a de-dope treatment. Then, the product was filtered, washed and dried. Thus, de-doping polyaniline (2) was obtained.

When the form of the de-doping polyaniline (2) was observed through a scanning electron microscope, the de-doping polyaniline (2) had a fiber-form having a diameter of 20 nm and an aspect ratio of 20. Further, when the electric conductivity of the de-doping polyaniline (2) was measured, in a similar manner to the de-doping polyaniline (1), the electric conductivity of the de-doping polyaniline (2) was equal to or less than the measurement lower limit, that is, equal to or less than 10⁻³ S/cm.

<Synthesis of De-Doping Polyaniline (3)>

5 g of aniline and 26.5 g of 50% 4-sulfophthalic acid aqueous solution were inserted to 100 g of ion exchange water, and stirred well such that the aniline and the 4-sulfophthalic acid aqueous solution acid are evenly dissolved in the ion exchange water. Then, this solution was cooled to 0 degrees Celsius. Thus, an aniline 4-sulfophthalic acid solution was prepared. Separately, an aqueous solution was prepared by dissolving 12 g of ammonium persulfate in 40 g of ion exchange water. The ammonium persulfate aqueous solution was slowly dropped into the an aniline 4-sulfophthalic acid solution while stirring the aniline 4-sulfophthalic acid solution. Then, this mixture was held at 0 degrees Celsius for five hours to carry out a reaction. The product was filtered, washed and dried. Thus, 6.7 g of polyaniline powder was obtained.

The polyaniline power was stirred in 100 g of 5% aqueous ammonia to perform a de-dope treatment. The product was filtered, washed and dried. Thus, de-doping polyaniline (3) was obtained.

When the form of the de-doping polyaniline was observed through a scanning electron microscope, the de-doping polyaniline (3) had a fiber-form having a diameter of 10 nm and an aspect ratio of 100. Further, when the electric conductivity of the de-doping polyaniline (3) was measured, in a similar manner to the de-doping polyaniline (1), the electric conductivity of the de-doping polyaniline (3) was equal to or less than the measurement lower limit, that is, equal to or less than 10⁻³ S/cm.

<Synthesis of bis(fluorosulfonyl)imide-Doped Polyaniline (1)>

15 g of bis(fluorosulfonyl)imide was dissolved in 100 mL of pure water. Further, 5 g of the de-doping polyaniline (1) was inserted into this solution. Then, the solution was stirred for twelve hours, and the product was filtered, washed and dried. Thus, bis(fluorosulfonyl)imide-doped polyaniline (1) was obtained.

When the bis(fluorosulfonyl)imide-doped polyaniline (1) was observed by the scanning electron microscope, the form of the de-doping polyaniline (1) was maintained as its was. Further, when the electric conductivity of the bis(fluorosulfonyl)imide-doped polyaniline (1) was measured in the similar manner to the de-doping polyaniline (1), the electric conductivity of the bis(fluorosulfonyl)imide-doped polyaniline (1) was 3.2 S/cm.

<Synthesis of bis(fluorosulfonyl)imide-Doped Polyaniline (2)>

15 g of bis(fluorosulfonyl)imide was dissolved in 100 mL of pure water. Further, 5 g of the de-doping polyaniline (2) was inserted into this solution. Then, the solution was stirred for twelve hours, and the product was filtered, washed and dried. Thus, bis(fluorosulfonyl)imide-doped polyaniline (2) was obtained.

When the bis(fluorosulfonyl)imide-doped polyaniline (2) was observed by the scanning electron microscope, the form of the de-doping polyaniline (2) was maintained as its was. Further, when the electric conductivity of the bis(fluorosulfonyl)imide-doped polyaniline (2) was measured in the similar manner to the de-doping polyaniline (1), the electric conductivity of the bis(fluorosulfonyl)imide-doped polyaniline (1) was 2.2 S/cm.

<Synthesis of bis(fluorosulfonyl)imide-Doped Polyaniline (3)>

15 g of bis(fluorosulfonyl)imide was dissolved in 100 mL of pure water. Further, 5 g of the de-doping polyaniline (3) was inserted into this solution. Then, the solution was stirred for twelve hours, and the products was filtered, washed and dried. Thus, bis(fluorosulfonyl)imide-doped polyaniline (3) was obtained.

When the bis(fluorosulfonyl)imide-doped polyaniline (3) was observed by the scanning electron microscope, the form of the de-doping polyaniline (3) was maintained as its was. Further, when the electric conductivity of the bis(fluorosulfonyl)imide-doped polyaniline (3) was measured in the similar manner to the de-doping polyaniline (1), the electric conductivity of the bis(fluorosulfonyl)imide-doped polyaniline (3) was 4.0 S/cm.

<Synthesis of De-Doping Polyaniline (4)>

5 g of aniline and 10 g of sulfuric acid 10 g were inserted into ion exchange water and stirred well. Then, this solution was cooled to 0 degrees Celsius. Thus, the aniline sulfuric acid solution was prepared. This solution was not uniform, and was turbid. Separately, an aqueous solution was prepared by dissolving 12 g of ammonium persulfate in 40 g of ion exchange water. The ammonium persulfate aqueous solution was slowly dropped into the aniline sulfuric acid solution while stirring the aniline sulfonic acid solution. Then, the mixed solution is held at 0 degrees Celsius for five hours to carry out a reaction. The product was filtered, washed and dried. Thus, 6 g of polyaniline powder was obtained.

The polyaniline power was stirred in 100 g of 5% aqueous ammonia to perform a dedope treatment. The product was filtered, washed and dried. Thus, de-doping polyaniline (4) was obtained.

When the de-doping polyaniline (4) was observed by the scanning electron microscope, the de-doping polyaniline (4) has a grain-aggregated form with a diameter of approximately 10 μm. When the electric conductivity of the de-doping polyaniline (4) was measured, the electric conductivity was equal to or less than the measurement limit, that is, equal to or lower than 10⁻³ S/cm.

<Synthesis of bis(fluorosulfonyl)imide-Doped Polyaniline (4)>

15 g of bis(fluorosulfonyl)imide was dissolved in 100 mL of pure water. Further, 5 g of the de-doping polyaniline (4) was inserted into this solution. The solution was stirred for twelve hours, and the product was filtered, washed and dried. Thus, bis(fluorosulfonyl)imide-doped polyaniline (4) was obtained.

When the bis(fluorosulfonyl)imide-doped polyaniline (4) was observed by the scanning electron microscope, the form of the de-doping polyaniline (4) was maintained as its was. Further, when the electric conductivity of the bis(fluorosulfonyl)imide-doped polyaniline (4) was measured in the similar manner to the de-doping polyaniline (1), the electric conductivity of the bis(fluorosulfonyl)imide-doped polyaniline (3) was 3.0 S/cm.

### Example 1

A coin-type lithium rechargeable battery as an example 1 was prepared in the following manner.

<Production of Positive Electrode>

A uniform coating fluid as a slurry was prepared by mixing and dispersing a positive-electrode active material, a binder, a conductive agent and a dispersion agent in a solvent. As the positive-electrode active material, 90 parts by mass of LiFePO₄, and 3 parts by mass of the de-doping polyaniline (1), which is the conductive polymer, were added. As the binder, 3 parts by mass of polyacrylic acid was added. As the conductive agent, 4 parts by mass of acetylene black and 2 parts by mass of the vapor-grown carbon fiber were added. As the dispersion agent, 1 part by mass of carboxymethylcellulose (CMC) was added.

The prepared slurry was applied to the positive-electrode collector composed of an aluminum thin film, dried and pressed. Thus, a positive electrode plate was prepared. The positive electrode plate was prepared such that the positive-electrode mixture has a thickness of 41 μm. In preparation of the slurry, water was used as the solvent.

<Preparation of Electrolyte Solution>

An electrolyte solution was prepared by adding LiPF₆ in an organic solvent in which ethylene carbonate (EC) and diethyl carbonate (DEC) are mixed at a mass ratio of 3:7. In this case, LiPF₆ was added to the organic solvent such that the concentration of LiPF₆ is 1.0 mol/L.

<Production of Coin-Type Lithium Rechargeable Battery>

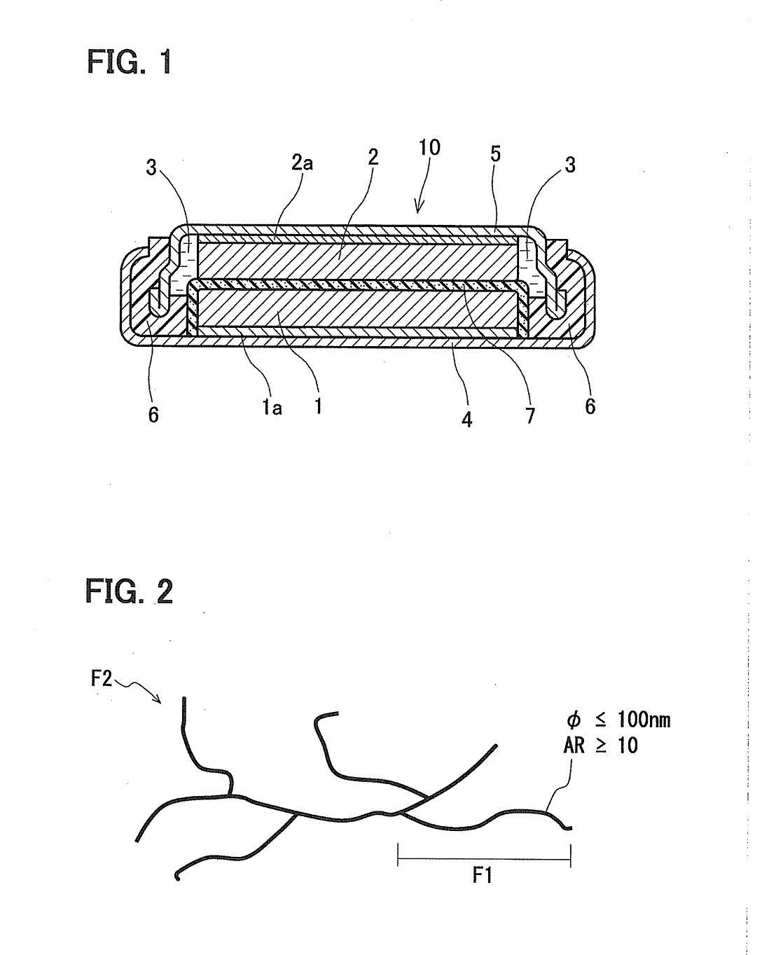

As shown in FIG. 1, the coin-type lithium rechargeable battery 10 was produced using the above-described materials. The lithium rechargeable battery 10 includes a positive electrode 1, a negative electrode 2, an electrolyte solution 3, and a separator 7. The positive electrode 1 is provided by the positive electrode produced as described above. The negative electrode 2 is made of a lithium metal. The electrolyte solution 3 is provided by the electrolyte solution prepared as described above. The separator 7 is made of a porous polyethylene film having a thickness of 25 μm. The positive electrode 1 includes a positive-electrode collector 1a. The negative electrode 2 includes a negative-electrode collector 2a.

These power-generation elements are disposed in a stainless case. The case is made of a positive-electrode case 4 and a negative-electrode case 5, for example. The positive-electrode case 4 serves as a positive-electrode terminal. The negative-electrode case 5 serves as a negative-electrode terminal. A polypropylene gasket 6 is disposed between the positive-electrode case 4 and the negative-electrode case 5 to seal between the positive-electrode case 4 and the negative-electrode case 5, and to keep electric insulation between the positive-electrode case 4 and the negative-electrode case 5.

<Evaluation of Capacitance Characteristic and Output Characteristic>

The lithium rechargeable battery 10 produced as the example 1 was charged to 4.1 V with an electric current corresponding to 1 C, and then discharged to 3.0 V with an electric current corresponding to 1 C. In this state, the discharge capacity was measured.

To evaluate the output characteristic, a state of charge (SOC) of the rechargeable battery was adjusted to 60% by a constant current charge of 330 μA, and a discharging current of the lithium rechargeable battery was changed while setting an operation lower limit voltage of the SOC 60% at 2.5 V. The voltage at 10 seconds after the beginning of discharging was calculated, and the battery output was obtained based on the calculated voltage. The evaluation results of the discharge capacity and the output are listed in table 1.

As shown in Table 1, the discharge capacity per mass of the positive-electrode mixture was 1.3 mAh/g and the battery output was 110 mW.

### Example 2

A lithium rechargeable battery as an example 2 was prepared in the similar manner to the example 1, except that the de-doping polyaniline (2) was used as the conductive polymer. The capacitance characteristic of the example 2 was measured in the similar manner to the example 1. As a result, the discharge capacity per mass of the positive electrode mixture was 1.3 mAh/g and the output was 100 mW. The measurement results are listed in the table 1.

### Example 3

A lithium rechargeable battery as an example 3 was prepared in the similar manner to the example 1, except that the de-doping polyaniline (3) was used as the conductive polymer. The capacitance characteristic of the example 3 was measured in the similar manner to the example 1.

As a result, the discharge capacity per mass of the positive electrode mixture was 1.3 mAh/g and the battery output was 121 mW. The measurement results are listed in the table 1.

### Example 4

A lithium rechargeable battery as an example 4 was prepared in the similar manner to the example 1, except that the bis(fluorosulfonyl)imide-doped polyaniline (1) was used as the conductive polymer. The capacitance characteristic of the example 4 was measured in the similar manner to the example 1.

As a result, the discharge capacity per mass of the positive electrode mixture was 1.3 mAh/g and the battery output was 152 mW. The measurement results are listed in the table 1.

### Example 5

A nonaqueous electrolyte rechargeable battery as an example 5 was prepared in the similar manner to the example 1, except that the bis(fluorosulfonyl)imide-doped polyaniline (2) was used as the conductive polymer. The capacitance characteristic of the example 5 was measured in the similar manner to the example 1.

As a result, the discharge capacity per mass of the positive electrode mixture was 1.3 mAh/g and the output was 132 mW. The measurement results are listed in the table 1.

### Example 6

A lithium rechargeable battery as an example 6 was prepared in the similar manner to the example 1, except that the bis(fluorosulfonyl)imide-doped polyaniline (3) was used as the conductive polymer. The capacitance characteristic of the example 6 was measured in the similar manner to the example 1.

As a result, the discharge capacity per mass of the positive electrode mixture was 1.3 mAh/g and the battery output was 170 mV. The measurement results are listed in the table 1.

### Comparative Example 1

A lithium rechargeable battery as a comparative example 1 was prepared in the similar manner to the example 1, except that the de-doping polyaniline (4) was used as the conductive polymer. The capacitance characteristic of the comparative example 1 was measured in the similar manner to the example 1.

As a result, the discharge capacity per mass of the positive electrode mixture was 1.3 mAh/g and the battery output was 80 mW. The measurement results are listed in the table 1.

### Comparative Example 2

A lithium rechargeable battery as a comparative example 2 was prepared in the similar manner to the example 1, except that the bis(fluorosulfonyl)imide-doped polyaniline (4) was used as the conductive polymer. The capacitance characteristic of the comparative example 2 was measured in the similar manner to the example 1.

As a result, the discharge capacity per mass of the positive electrode mixture was 1.3 mAh/g and the battery output was 86 mW. The measurement results are listed in the table 1.

### Comparative Example 3

A lithium rechargeable battery as a comparative example 3 was prepared in the similar manner to the example 1, except that LiFePO₄ was used as the positive-electrode active material without adding the conductive polymer. The capacitance characteristic of the comparative example 3 was measured in the similar manner to the example 1.

As a result, the discharge capacity per mass of the positive electrode mixture was 1.3 mAh/g and the battery output was 70 mW. The measurement results are listed in the table 1.

Further, the lithium rechargeable batteries of the examples 1-6 and the comparative examples 1-3 were stored for one week at 60 degrees Celsius, and the battery characteristics were measured again. As a result, it was confirmed that each of the lithium rechargeable batteries has substantially the same battery characteristics as they had before the storing.

TABLE 1

| | Conductive Polymer | | | | | Battery | |
|---|---|---|---|---|---|---|---|
| | | | | Electric | | Evaluation | |
| | | | Aspect | Conductivity | Non-soluble to | Capacity | Output |
| | Fiber | Dopant | Ratio | (S/cm) | Electrolyte | (mAh) | (mW) |
| Ex 1 | PANI | | 50 | 10⁻³ or less | Yes | 1.3 | 110 |
| Ex 2 | | | 20 | 10⁻³ or less | Yes | 1.3 | 100 |
| Ex 3 | | | 100 | 10⁻³ or less | Yes | 1.3 | 121 |
| Ex 4 | | bis(fluorosulfonyl)imide | 50 | 3.2 | Yes | 1.3 | 152 |
| Ex 5 | | bis(fluorosulfonyl)imide | 20 | 2.2 | Yes | 1.3 | 132 |
| Ex 6 | | bis(fluorosulfonyl)imide | 100 | 4.0 | Yes | 1.3 | 170 |
| Cmp Ex 1 | | | 1 | 10⁻³ or less | Yes | 1.3 | 80 |
| Cmp Ex 2 | | bis(fluorosulfonyl)imide | 1 | 3.0 | Yes | 1.3 | 86 |
| Cmp Ex 3 | | | | | | 1.3 | 70 |

As shown in Table 1, it is appreciated that the lithium rechargeable batteries containing the conductive polymer with the predetermined form exert excellent initial capacity and output. Also, it is appreciated that the lithium rechargeable batteries exerts excellent performance, even if the aqueous solvent is used in the production of the electrode (e.g., positive electrode).

For example, as shown in FIG. 2, the predetermined form of the conductive polymer is a fiber-form F1 having a fiber diameter (φ) of equal to or less than 100 nm and an aspect ratio (AR) of equal to or greater than 10, or a three-dimensional structure F2 made of the fiber-form as the base.

With regard to the lithium rechargeable batteries of the comparative examples 1 and 2 in which the aspect ratio of the conductive polymer is too small, such as less than 10, and the lithium rechargeable battery of the comparative example 3 without containing the conductive polymer, the battery capacity is substantially the same as the battery capacities of the lithium rechargeable batteries of the examples 1-6. However, the output of the lithium rechargeable batteries of the comparative examples 1-3 is much lower than that of the lithium rechargeable batteries of the examples 1-6.

As described above, with regard to the coin-type lithium rechargeable batteries of the examples 1 to 6, it is appreciated that resistance characteristic of the electrode and cycle characteristic are improved.

The advantageous effects of the examples described above are achieved irrespective of composition of the electrodes. Therefore, the present embodiment may not be limited by a composition ratio of materials forming the electrode.

While only the selected exemplary embodiments have been chosen to illustrate the present disclosure, it will be apparent to those skilled in the art from this disclosure that various changes and modifications can be made therein without departing from the scope of the disclosure as defined in the appended claims. Furthermore, the foregoing description of the exemplary embodiments according to the present disclosure is provided for illustration only, and not for the purpose of limiting the disclosure as defined by the appended claims and their equivalents.

What is claimed is:

1. A nonaqueous electrolyte rechargeable battery comprising:
a positive electrode having a positive-electrode active material that occludes and discharges an alkali metal ion;
a negative electrode having a negative-electrode active material that occludes and discharges an alkali metal ion; and
an electrolyte solution, wherein
at least one of the positive electrode and the negative electrode contains a conductive polymer having one of a fiber-form and a three-dimensional structure provided by the fiber-form as a base, the fiber-form having a fiber diameter of equal to or less than 100 nm in a cross-section defined perpendicular to a longitudinal axis thereof and an aspect ratio of equal to or greater than 10.

2. The nonaqueous electrolyte rechargeable battery according to claim 1, wherein
the conductive polymer is provided by polymerization of one of aniline and a derivative of the aniline as a monomer unit, the aniline being represented by formula 1, in which R₁ to R₇ are selected from the group consisting of hydrogen, straight-chain or branched alkyl group a carbon number of which is from 1 to 6, straight-chain or branched alkoxy group a carbon number of which is from 1 to 6, hydroxyl group, nitro group, amino group, phenyl group, amino phenyl group, diphenyl amino group and halogen group,

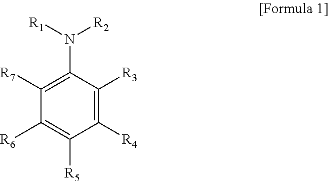

3. The nonaqueous electrolyte rechargeable battery according to claim 1, wherein
the conductive polymer is provided by polymerization of one of aniline and a derivative of the aniline as a monomer unit, and is doped with bis(fluorosulfonyl)imide as a dopant.

4. The nonaqueous electrolyte rechargeable battery according to claim 1, wherein the alkali metal ion is a lithium ion.

5. The nonaqueous electrolyte rechargeable battery according to claim 1, wherein
the positive-electrode active material includes a lithium transition metal composite compound, and
the conductive polymer is contained in the positive electrode.
